(19) United States
(12) Patent Application Publication
(10) Pub. No.: US 2008/0238958 A1
(43) Pub. Date: Oct. 2, 2008

(54) CARRIAGE, RECORDING APPARATUS, AND LIQUID EJECTING APPARATUS

(75) Inventor: Hiroki NAKASHIMA, Fukuoka-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: Seiko Epson Corporation, Tokyo (JP)

(21) Appl. No.: 12/057,634

(22) Filed: Mar. 28, 2008

(30) Foreign Application Priority Data
Mar. 30, 2007 (JP) 2007-095643

(51) Int. Cl. B41J 25/308

(52) U.S. Cl. 347/8

(57) ABSTRACT

A carriage carries a recording unit and is movable while being supported by a guiding member. The recording unit performs recording on a recording medium in a scanning direction in which the guiding member extends and the carriage moves with the recording unit. The carriage includes a guided member that is in contact with the guiding member at two positions spaced apart from each other by a distance d in the scanning direction. The guided member is swingable in conformity with a bend in the guiding member while moving in the scanning direction. When the guiding member is supported by a plurality of supporting members provided at a span L in the scanning direction, the distance d satisfies Expression (1) below:

d=(n+α)×L (1)

where n is 0 or an integer of 1 at the smallest, and 0<α<1.0.

### BACKGROUND

1. Technical Field

The present invention relates to carriages carrying a recording unit that perform recording on a recording medium, and recording apparatuses including the same. The invention also relates to liquid ejecting apparatuses.

Herein, liquid ejecting apparatuses are not limited to recording apparatuses such as printers, copiers, and facsimiles that include an ink jet recording head and perform recording on a recording medium by ejecting ink from the recording head. Liquid ejecting apparatuses include apparatuses that cause a liquid ejecting head, an equivalent of the ink jet recording head, to eject liquid, a material suitable for the required use instead of ink, toward an ejection target, an equivalent of the recording medium, so that the liquid adheres to the ejection target.

Examples of the liquid ejecting head other than the recording head include colorant ejecting heads used in manufacturing color filters of liquid crystal displays, electrode-material (conductive-paste) ejecting heads used in forming electrodes of organic electroluminescence (EL) displays and surface-emitting displays (field emission displays abbreviated as FEDs), bioorganic-material ejecting heads used in manufacturing biochips, and sample ejecting heads used as precision pipettes.

2. Related Art

In a recording apparatus or a liquid ejecting apparatus represented by a printer, a recording head as a recording unit is mounted on a reciprocatable carriage. The recording head is supported and guided by a guiding shaft extending in a direction in which the recording head is moved for scanning (hereinafter referred to as the “main scanning direction”).

In some cases, as in the apparatus disclosed in JP-A-2002-79720 including a “guiding shaft” and a “frame member”, the carriage is supported by two guiding units, whereby the distance between the head surface of the recording head and the recording paper is regulated.

In the case where a sliding unit for facilitating the sliding movement of a carriage along a frame member is secured to the carriage, if the frame member has a bend, the carriage may tend to be tilted while moving in the main scanning direction. To avoid this, the apparatus disclosed in JP-A-2002-79720 is configured such that the sliding unit is swingable in conformity with the bend in the frame member, whereby a stable carriage operation is achieved.

In JP-A-2002-79720, however, the distance between the head surface of the recording head and the recording paper is regulated by supporting the carriage with the frame member. Therefore, if the frame member has a bend, the carriage may swing about the guiding shaft while moving in the main scanning direction (such a phenomenon is hereinafter referred to as a “head swinging phenomenon” of the carriage). This may change the parallelism or distance between the head surface of the recording head and the recording paper. Consequently, the recording quality may be degraded.

Such a technical problem is not considered in the recording apparatus disclosed in JP-A-2002-79720. Moreover, JP-A-2002-79720 neither describes nor suggests the relationship between the supporting span and the carriage in the case where the guiding shaft or the frame member is supported at two or more positions.

### SUMMARY

An advantage of some aspects of the invention is to prevent or lower the degree of change in parallelism or distance between a head surface of a recording head and a recording paper occurring in response to a head swinging phenomenon of a carriage.

According to a first aspect of the invention, a carriage carrying a recording unit and movable while being supported by a guiding member is provided. The recording unit performs recording on a recording medium in a scanning direction in which the guiding member extends and the carriage moves with the recording unit. The carriage includes a guided member that is in contact with the guiding member at two positions spaced apart from each other by a distance d in the scanning direction. The guided member is swingable in conformity with a bend in the guiding member while moving in the scanning direction. When the guiding member is supported by a plurality of supporting members provided at a span L in the scanning direction, the distance d satisfies Expression (1) below:

d=(n+α)×L (1)

where n is 0 or an integer of 1 at the smallest, and 0<α<1.0.

In the first aspect, the guided member supported by the guiding member is in contact with the guiding member at two positions spaced apart from each other by the distance d in the scanning direction in which the recording unit is moved. The distance d is of a smaller value than the span L at which the guiding member is supported or the sum of the smaller value and an integral multiple of the span L. That is, even if the guiding member has a bend, the size of the bend is not directly reflected on the displacement of the guided member, but the displacement of the guided member is smaller than the size of the bend. Consequently, the head swinging phenomenon of the carriage is eased, whereby degradation of recording quality due to the head swinging phenomenon of the carriage can be prevented or reduced.

According to a second aspect of the invention, a carriage carrying a recording unit and movable while being supported by a guiding member is provided. The recording unit performs recording on a recording medium in a scanning direction in which the guiding member extends and the carriage moves with the recording unit. The carriage includes a guided member that is in contact with the guiding member at two positions spaced apart from each other by a distance d in the scanning direction. The guided member is swingable in conformity with a bend in the guiding member while moving in the scanning direction. When the guiding member has periodic bends at a span L in the scanning direction, the distance d satisfies Expression (1) below:

d=(n+α)×L (1)

where n is 0 or an integer of 1 at the smallest, and 0<α<1.0.

In the second aspect, the same as in the first aspect, the distance d is of a smaller value than the period of bends (span L) in the guiding member or the sum of the smaller value and an integral multiple of the span L. That is, even if the guiding member has a bend, the size of the bend is not directly reflected on the displacement of the guided member, but the displacement of the guided member is smaller than the size of the bend. Consequently, the head swinging phenomenon of the carriage is eased, whereby degradation of recording quality due to the head swinging phenomenon of the carriage can be prevented or reduced.

In the first aspect of the invention, it is preferable that Expression (1) have a condition of 0.35<α<0.65. In such a case, the displacement of the guided member can be reduced to 50% or lower of that in the case where α=1.0. Thus, the head swinging phenomenon of the carriage can be eased markedly.

According to a third aspect of the invention, a recording apparatus is provided. The recording apparatus includes a guiding member extending in a scanning direction in which a recording unit performs recording on a recording medium, and the carriage according to the first aspect of the invention supported by the guiding member. In the third aspect, the recording apparatus can produce the same advantage as that produced in the first aspect.

According to a fourth aspect of the invention, a liquid ejecting apparatus is provided. The liquid ejecting apparatus includes a liquid ejecting unit having a liquid ejecting nozzle through which liquid is ejected toward an ejection target, a guiding member extending in a scanning direction in which the liquid ejecting unit is moved, and a carriage carrying the liquid ejecting unit and supported by the guiding member so as to be movable in the scanning direction. The carriage includes a guided member that is in contact with the guiding member at two positions spaced apart from each other by a distance d in the scanning direction. The guided member is swingable in conformity with a bend in the guiding member while moving in the scanning direction. When the guiding member is supported by a plurality of supporting members provided at a span L in the scanning direction, the distance d satisfies Expression (1) below:

d=(n+α)×L (1)

where n is 0 or an integer of 1 at the smallest, and 0<α<1.0.

### BRIEF DESCRIPTION OF THE DRAWINGS

The invention will be described with reference to the accompanying drawings, wherein like numbers reference like elements.

FIG. 1 is an external perspective view of a printer according to a first embodiment of the invention.

FIG. 2 is a side view of a relevant part of the printer according to the first embodiment of the invention.

FIG. 3 is a perspective view of a relevant part showing a manner for supporting a guiding shaft and a guiding plate.

FIG. 4 is a perspective view showing a carriage, a slider, and the guiding plate.

FIG. 5 is a front view showing the guiding plate and the slider.

FIG. 6A is a schematic diagram showing the deformation of the guiding plate and the vertical movement of the slider, in which a distance d is expressed as d=10.0×L.

FIG. 6B is a schematic diagram showing the deformation of the guiding plate and the vertical movement of the slider, in which a distance d is expressed as d=0.5×L.

FIG. 7 is a graph showing the relationship between α and the percentage of change in displacement of the slider.

FIG. 8 is a perspective view showing a relevant part of a carriage according to a second embodiment of the invention.

### DESCRIPTION OF EXEMPLARY EMBODIMENTS

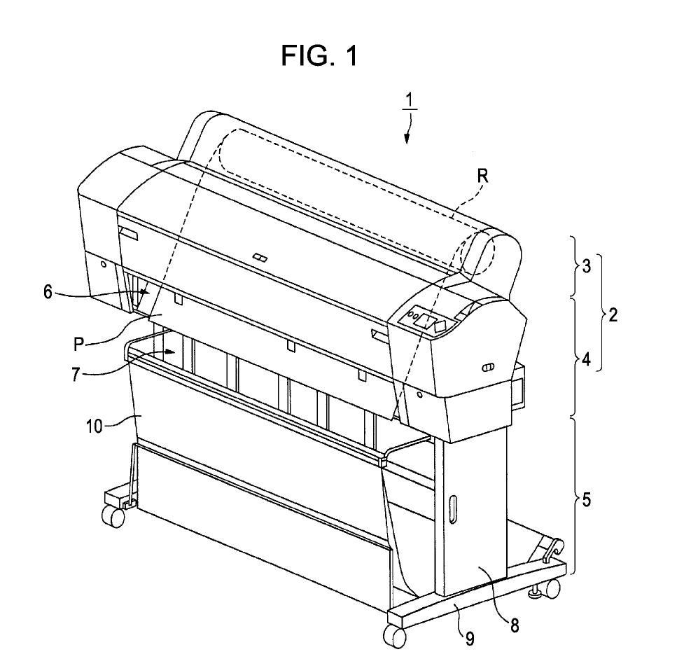

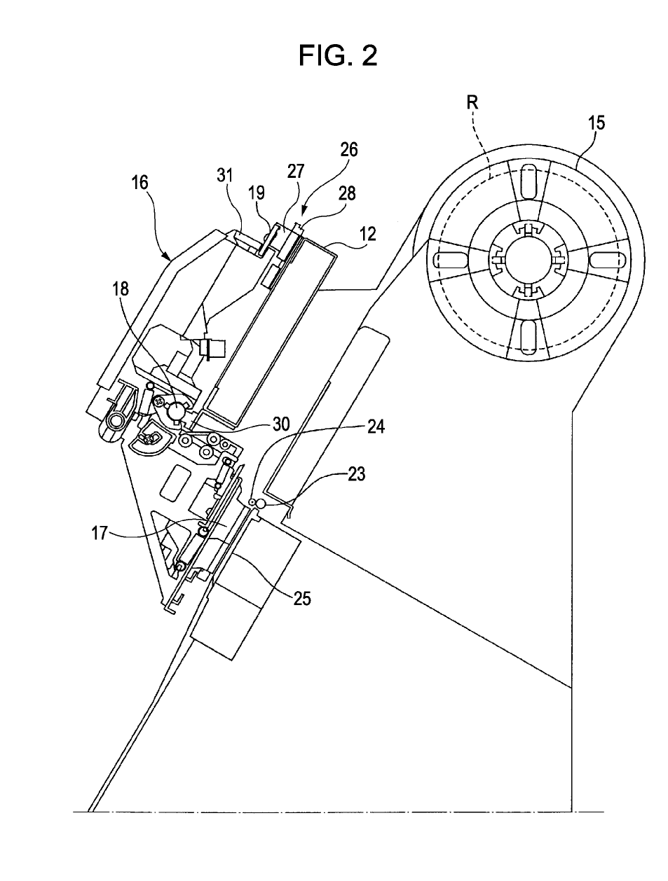

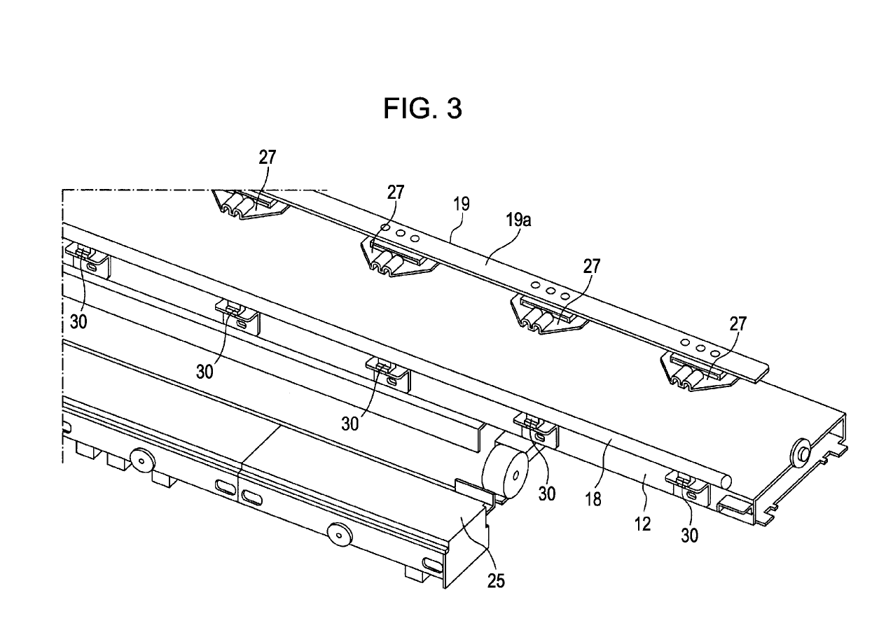

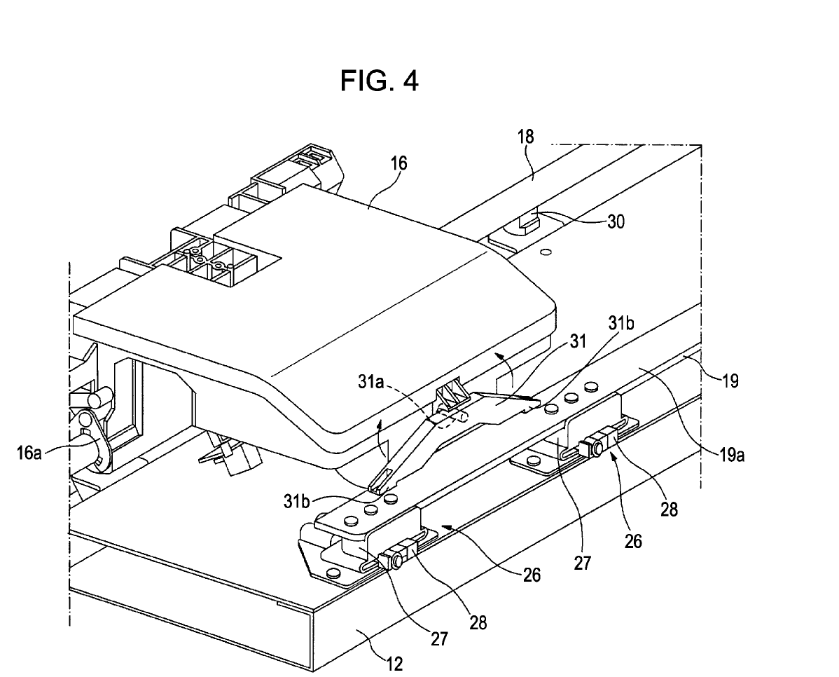

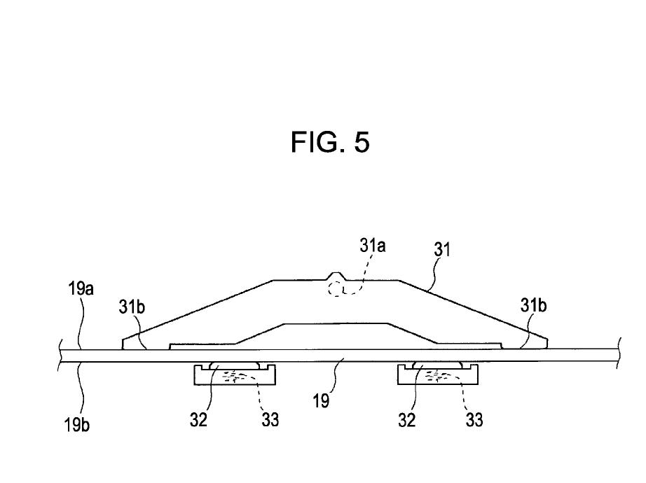

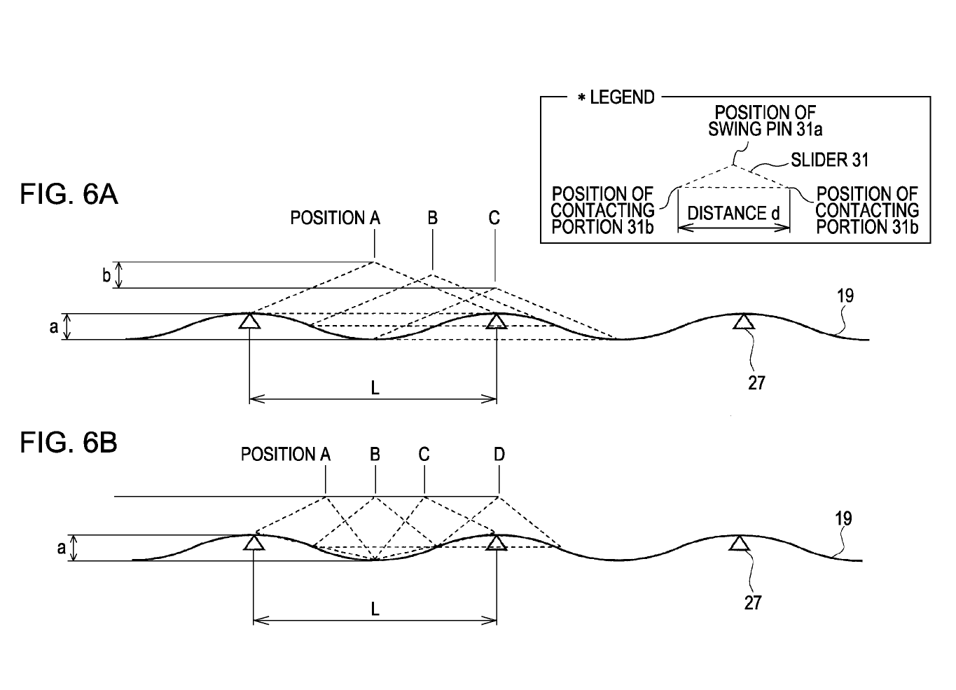

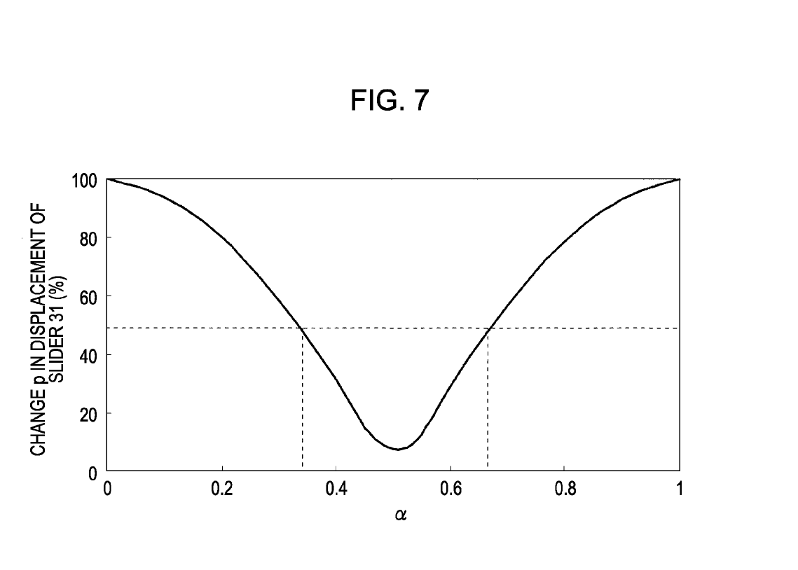

Embodiments of the invention will now be described with reference to FIGS. 1 to 8. FIG. 1 is an external perspective view of an ink jet printer (hereinafter referred to as a “printer”) 1 as an exemplary “recording apparatus” or a “liquid ejecting apparatus” according to a first embodiment of the invention. FIG. 2 is a side view of a relevant part of the same. FIG. 3 is a perspective view showing a manner for supporting a guiding shaft 18 and a guiding plate 19. FIG. 4 is a perspective view of a carriage 16, a slider 31, and the guiding plate 19. FIG. 5 is a front view of the slider 31, sliders 32, and the guiding plate 19. FIGS. 6A and 6B are schematic diagrams showing the deformation of the guiding plate 19 and the vertical movement of the slider 31. FIG. 6A shows the case where a distance d is expressed as d=10.0×L. FIG. 6B shows the case where the distance d is expressed as d=0.5×L. FIG. 7 is a graph showing the relationship between α and the percentage of change in displacement of the slider 31.

The configuration of the printer 1 will be outlined with reference to FIGS. 1 and 2. The printer 1 is a large printer capable of performing recording on roll paper (recording medium) P with a relatively large width, for example, as large as the A0 or B0 size according to the Japanese Industrial Standards (JIS). The printer 1 includes a main body 2 constituted by a roll-paper feeding unit 3 and a recording execution unit 4, and an ejected-paper receiving unit 5.

The main body 2 is disposed atop of a support 8 standing upright on a base 9, and includes an ejection port 6 through which the roll paper P after being subjected to recording is ejected downward at an angle. A stacker 10 has an opening 7 positioned below the ejection port 6. The roll paper P after recording is ejected through the ejection port 6 toward the opening 7 and then received by the stacker 10.

The roll-paper feeding unit 3 can house a roll-paper roll (hereinafter referred to as a “roll”) R. The roll paper P is fed downward at an angle from the roll R toward the recording execution unit 4 that executes recording. Referring to FIG. 2, a roll paper holder 15 is constituted by a spindle (not shown) extending through a hollow core of the roll R, and collars (disk-like members, one of which is shown in FIG. 2) provided at both ends of the spindle. The roll R is fitted with the roll paper holder 15. The roll paper holder 15 is driven to rotate by a driving mechanism (not shown), whereby the roll paper P is fed downstream.

The recording execution unit 4 includes a recording head 17 that ejects ink as liquid toward the roll paper P, a platen 25 disposed to face the recording head 17, a driving transportation roller 23 that is provided on the upstream side with respect to the recording head 17 for transporting the roll paper P downstream, and a driven transportation roller 24 that is pressed into contact with the driving transportation roller 23.

The recording head 17, which has a plurality of ink ejection nozzles functioning as dot forming elements that form dots on the roll paper P when ink is ejected therethrough, is mounted on the carriage 16. The carriage 16, which is driven by a motor (not shown), moves with the recording head 17 in a direction in which scanning is performed (the main scanning direction, i.e., the depth direction in FIG. 2) while being guided by the guiding shaft 18 as a first guiding member and the guiding plate 19 as a second guiding member both extending in the main scanning direction.

The carriage 16 is supported by the guiding shaft 18 and the guiding plate 19, whereby the distance between the head surface of the recording head 17 and the roll paper P is regulated. Herein, the distance between the head surface of the recording head 17 and the roll paper P implies that parallelism exists between the head surface of the recording head 17 and the roll paper P.

On the downstream side with respect to the recording head 17, a paper suction unit (not shown) is provided. With this paper suction unit, the roll paper P is made to be still and is prevented from floating at the downstream side with respect to the recording head 17. Consequently, the degradation of recording quality due to floating of the roll paper P can be prevented.

The outline of the printer 1 is as described above. Now, additionally referring to FIGS. 3 to 7, the carriage 16 and in particular the slider 31 provided on the carriage 16 will be described in detail.

Referring to FIGS. 2 and 3, a base frame 12 extends in the main scanning direction. The base frame 12 is provided with a plurality of supporting members 30 arranged in the main scanning direction at an almost constant span. The supporting members 30 support the guiding shaft 18. The base frame 12 is also provided with a plurality of supporting members 27 arranged in the main scanning direction at an almost constant span, in the same manner as of the supporting members 30. The supporting members 27 support the guiding plate 19.

Each supporting member 27 constitutes an adjusting unit 26 in combination with a spacer 28. Each spacer 28 can slide on the supporting member 27 engaging therewith, whereby the height at which the guiding plate 19 is supported can be adjusted for the individual supporting members 27. Herein, the height at which the guiding plate 19 is supported is a distance in a direction orthogonal to a flat sliding surface 19a of the guiding plate 19.

The carriage 16 is provided with bearings 16a as first guided members secured at both ends thereof in the main scanning direction. The guiding shaft 18 extends through the bearings 16a, thereby supporting the carriage 16 at the bearings 16a. In FIG. 4, one of the bearings 16a is hidden behind the carriage 16.

The guiding plate 19 is disposed at a predetermined distance on the upstream side with respect to the guiding shaft 18 in the roll-paper transporting direction. The carriage 16 is also provided with the sliders 31 and 32 as second guided members provided at predetermined distances on the upstream side with respect to the bearings 16a so as to engage with the guiding plate 19.

Referring to FIGS. 2 and 5, the sliders 31 and 32 are disposed so as to sandwich the guiding plate 19. While the carriage 16 moves in the main scanning direction, the sliders 31 and 32 are slidably in contact with the guiding plate 19. The carriage 16 tends to turn about the guiding shaft 18 counterclockwise in FIG. 2 because of the dead load of the carriage 16. This turning of the carriage 16 is stopped by the guiding plate 19. Therefore, if the guiding plate 19 has a bend and the carriage 16 moves thereon in the main scanning direction, the carriage 16 may swing about the guiding shaft 18 (a head swinging phenomenon).

The slider 31 has two contacting portions 31b that are positioned at a predetermined distance from each other in the main scanning direction and are in contact with the sliding surface 19a of the guiding plate 19, and a swing pin 31a with which the slider 31 is attached to the main body of the carriage 16. This structure makes the slider 31 swingable in conformity with the bend in the guiding plate 19 (in a direction indicated by arrows in FIG. 4) while the carriage 16 is moving in the main scanning direction.

Referring to FIG. 5, a pair of the sliders 32 are disposed at a predetermined interval in the main scanning direction while being in contact with a sliding surface 19b of the guiding plate 19. Each of the sliders 32 is urged by a compression spring 33 so as to be pressed into contact with the guiding plate 19. In this manner, the guiding plate 19 is pinched between the slider 31 and the sliders 32 with the aid of the force of the compression springs 33.

The carriage 16 tends to turn about the guiding shaft 18 counterclockwise in FIG. 2 because of the dead load of the carriage 16. This turning of the carriage 16 is stopped by the guiding plate 19. In this state, the sliders 32 are pressed into contact with the guiding plate 19 because of the dead load of the carriage 16. Further, the compression springs 33 cause the guiding plate 19 to be pinched between the slider 31 and the sliders 32 as described above. This means that the slider 31 is also pressed into contact with the sliding surface 19a of the guiding plate 19. Moreover, since the sliders 32 are displaceable relative to the sliding surface 19b of the guiding plate 19, if the guiding plate 19 has a bend, the influence of the bend is transmitted to the slider 31 (i.e., the main body of the carriage 16).

In this case, the guiding plate 19 tends to bend downward in regions thereof between the supporting members 27 while being subjected to the load of the carriage 16. This causes the guiding plate 19 to undulate in the main scanning direction. The slider 31 having the two contacting portions 31b can swing in conformity with the undulation.

The distance d between the two contacting portions 31b is set with respect to a supporting span L, at which the guiding plate 19 is supported, so as to satisfy Expression (1) below:

d=(n+α)×L (1)

In Expression (1), n is 0 or an integer of 1 or larger, and α is a positive value that satisfies 0<α<1.0.

The reason why the distance d is set as described above will be described in detail with reference to FIGS. 6A and 6B. In FIGS. 6A and 6B, a reference numeral 27 denotes a position of each supporting member 27 that supports the guiding plate 19, a reference numeral 19 denotes the guiding plate 19 undulating by bending downward between the supporting members 27, and a reference character L denotes the supporting span. Further, a triangle shown in the legend for FIGS. 6A and 6B schematically shows the slider 31. The vertex of the triangle represents the position of the swing pin 31a, the base corners represent the positions of the contacting portions 31b.

FIG. 6A shows the case where the distance d between the contacting portions 31b is equal to the span L (n=0, α=1.0). A reference character a denotes the size of the bend in the guiding plate 19 (the height difference between peaks and valleys in the undulation). When the carriage 16 moves from a position A through a position B to a position C, or rightward in FIG. 6A, the vertical position of the slider 31 changes in conformity with the undulation of the guiding plate 19 because the distance d between the contacting portions 31b is equal to the span L. Consequently, a displacement b of the slider 31 becomes equal to the size of the bend a in the guiding plate 19.

When the slider 31 is largely displaced in the vertical direction as in the above-described case, the phenomenon in which the carriage 16 swings about the guiding shaft 18 (the head swinging phenomenon) may become more noticeable. This considerably changes the distance and parallelism between the recording head 17 and the roll paper P, thereby considerably degrading the recording quality.

To avoid such a situation, the distance d between the contacting portions 31b is set to a value smaller than the span L or to the sum of the smaller value and the span L. FIG. 6B shows the case where the distance d between the contacting portions 31b is ½ of the span L (n=0, α=0.5). The carriage 16 moves from a position A through positions B and C to a position D, or rightward in FIG. 6B. At the position A, for example, one of the contacting portions 31b resides in a valley in the undulation of the guiding plate 19, while the other contacting portion 31b resides on a peak.

Therefore, the slider 31 only swings about the swing pin 31a, almost without being displaced in the vertical direction. Likewise, at the positions B, C, and D, the slider 31 swings about the swing pin 31a as shown in FIG. 6B, whereby the vertical displacement of the slider 31 is suppressed to be extremely small.

Thus, when the distance d between the contacting portions 31b is set to a value smaller than the span L or to the sum of the smaller value and the span L, the slider 31 can swing and thus be prevented from being largely displaced in the vertical direction in conformity with the undulation of the guiding plate 19. That is, the head swinging phenomenon of the carriage 16 can be eased. Accordingly, the distance and parallelism between the head surface of the recording head 17 and the roll paper P can be prevented from changing largely, whereby a severe degradation of recording quality can be prevented.

FIG. 6B is based on the case where α is 0.5 in Expression (1) defined above. However, only if α is set to a value close to 0.5, can the displacement b of the slider 31 effectively be made smaller than that in the case (α=1.0) shown in FIG. 6A. Accordingly, the degradation of recording quality can be reduced.

FIG. 7 is a graph showing the result of a calculation for obtaining the relationship between α and the percentage of change p in displacement b of the slider 31. This graph shows that a setting of a in Expression (1) above to a value closer to 0.5 effectively leads to a smaller displacement b of the slider 31. The percentage of change p is calculated as p=[b/b₁]×100, where b₁ is a displacement b when α=1.0.

Particularly within the range of 0.35<α<0.65, the displacement b of the slider 31 can be suppressed to 50% or lower. When α in Expression (1) is set to 0.5, the displacement b of the slider 31 can be made the smallest.

In the first embodiment, the span L in Expression (1) is defined as a span at which the guiding plate 19 is supported (the interval between the supporting members 27). This is based on the premise that the bend in the guiding plate 19, if any, is always a downward bend between each two of the supporting members 27. In other words, the period of bends in the guiding plate 19 and the span at which the guiding plate 19 is supported are considered to be equal.

Therefore, if the period of bends in the guiding plate 19 and the supporting span are not equal, the period of bends in the guiding plate 19 is preferably used instead of the span L in Expression (1). Even if the period of bends in the guiding plate 19 is not constant, that is, even if the guiding plate 19 has irregular bends, the displacement of the slider 31 can be made smaller because the slider 31 is in contact with the guiding plate 19 at two positions. Accordingly, the head swinging phenomenon of the carriage 16 can be eased.

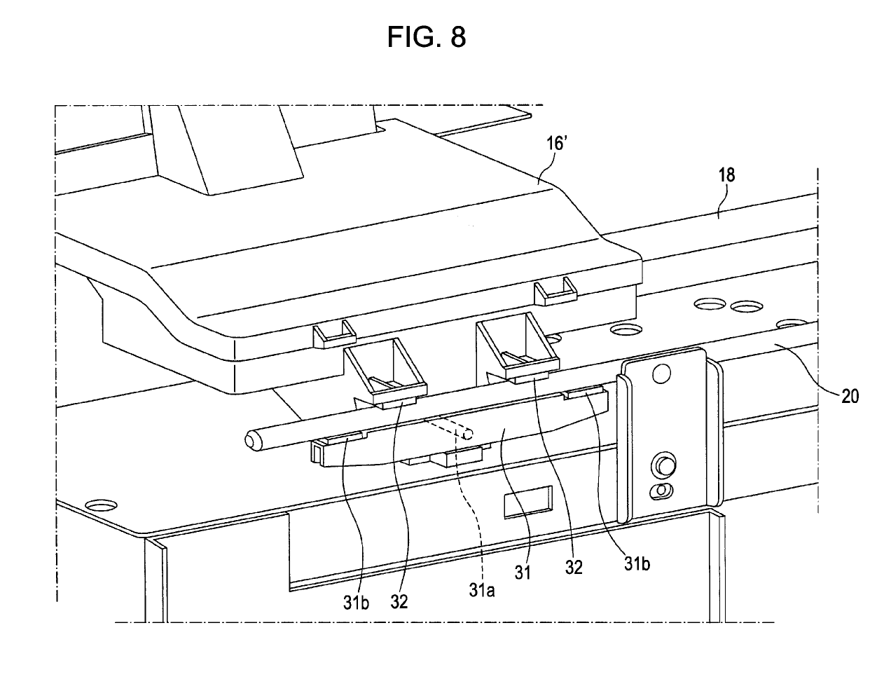

In the first embodiment, the carriage 16 is supported by the guiding shaft 18 as a shaft element and the guiding plate 19 as a plate element. However, referring to FIG. 8, which is a perspective view of a relevant part of a carriage according to a second embodiment, a guiding shaft 20 as a shaft element may be used instead of the guiding plate 19.

Although in the first embodiment the swingable slider 31 is brought into contact with the guiding plate 19 from above, the invention is not limited thereto. As shown in FIG. 8, the slider 31 may be brought into contact with the guiding shaft 20 from below.

With such a configuration, the slider 31 is pressed into contact with the guiding shaft 20 while being subjected to the dead load of the carriage 16′. This eliminates the need to largely increase the force of the compression springs 33 that urges the sliders 32 provided opposite the slider 31. That is, the force of pinching the guiding shaft 20 between the slider 31 and the sliders 32 can be made smaller. Thus, the carriage 16′ can be driven in the main scanning direction with a smaller load.

The first and second embodiments concern the case where the invention is applied to an ink jet printer as an exemplary recording apparatus. In addition to such a recording apparatus including a recording unit (recording head) that performs recording by ejecting ink toward a recording medium as described above, the invention may naturally be applied to a dot impact printer including a recording unit (recording head) that performs recording by striking a dot wire against a recording medium.

What is claimed is:

1. A carriage carrying a recording unit and movable while being supported by a guiding member, the recording unit performing recording on a recording medium in a scanning direction in which the guiding member extends and the carriage moves with the recording unit, the carriage comprising:
a guided member that is in contact with the guiding member at two positions spaced apart from each other by a distance d in the scanning direction,
wherein the guided member is swingable in conformity with a bend in the guiding member while moving in the scanning direction, and
wherein, when the guiding member is supported by a plurality of supporting members provided at a span L in the scanning direction, the distance d satisfies Expression (1) below:
d=(n+α)×L (1)
where n is 0 or an integer of 1 at the smallest, and 0<α<1.0.

2. A carriage carrying a recording unit and movable while being supported by a guiding member, the recording unit performing recording on a recording medium in a scanning direction in which the guiding member extends and the carriage moves with the recording unit, the carriage comprising:
a guided member that is in contact with the guiding member at two positions spaced apart from each other by a distance d in the scanning direction,
wherein the guided member is swingable in conformity with a bend in the guiding member while moving in the scanning direction, and
wherein, when the guiding member has periodic bends at a span L in the scanning direction, the distance d satisfies Expression (1) below:
d=(n+α)×L (1)
where n is 0 or an integer of 1 at the smallest, and 0<α<1.0.

3. The carriage according to claim 1, wherein Expression (1) has a condition of 0.35<α<0.65.

4. A recording apparatus comprising:
a guiding member extending in a scanning direction in which a recording unit performs recording on a recording medium; and
the carriage according to claim 1 supported by the guiding member.

5. A liquid ejecting apparatus comprising:
a liquid ejecting unit having a liquid ejecting nozzle through which liquid is ejected toward an ejection target;
a guiding member extending in a scanning direction in which the liquid ejecting unit is moved; and
the carriage according to claim 1 carrying the liquid ejecting unit and supported by the guiding member so as to be movable in the scanning direction.
